(19) United States
(12) Patent Application Publication
(10) Pub. No.: US 2026/0182779 A1
(43) Pub. Date: Jul. 2, 2026

(54) TOASTER COMPRISING RECHARGEABLE ENERGY ACCUMULATOR

(71) Applicant: Arno FRIEDRICHS, Kulmbach (DE)

(72) Inventor: Arno FRIEDRICHS, Kulmbach (DE)

(21) Appl. No.: 19/127,513

(22) PCT Filed: Sep. 28, 2023
(86) PCT No.: PCT/EP2023/076928

§ 371 Date: May 6, 2025

(30) Foreign Application Priority Data
Nov. 7, 2022 (DE) 10 2022 129 363.7

(51) Int. Cl. A47J 37/08

(52) U.S. Cl. CPC A47J 37/0842

(57) ABSTRACT

A toaster includes a housing; an insertion slot on the upper face of the housing; a heating chamber extending downwards from the insertion slot in the vertical direction; adjacent heating elements on both sides of the heating chamber; a rechargeable energy accumulator; and an operating device, wherein the operating device includes an operating module that is inserted into the housing, is accessible from the outside and contains a touch input field on which operating commands can be input or selected and on which data can be displayed.

The invention relates to a toaster with a rechargeable energy storage device. When the energy storage device is charged, such a toaster can be transported to a desired location without the use of a power cord and operated there for a limited time, for example to toast slices of bread.

U.S. Pat. No. 3,650,202 A discloses a portable toaster with a rechargeable battery positioned in its housing. In the lower part of this housing, there is a plug accessible from the outside to which a cable connected to an AC power supply can be plugged in to recharge the battery. The rechargeable battery remains in the housing of the toaster during recharging.

US 2008/0083739 A1 discloses another portable toaster. It can be operated using various energy sources. These energy sources include a hand-operated crank, an AC power supply, a DC power supply connected via a cable and a rechargeable battery. Furthermore, this toaster has a cover on its upper side to protect it from the weather.

The invention is based on the objective of providing a toaster that can be operated without a power cord, includes a rechargeable energy storage device and whose operation is improved.

The objective is solved by a toaster with the features specified in patent claim 1. Advantageous embodiments and further designs of such a toaster are specified in the dependent claims.

A toaster according to the present invention includes a housing, an insertion slot provided on the upper side of the housing, a heating chamber extending vertically downward from the insertion slot, heating elements adjacent to both sides of the heating chamber, a rechargeable energy storage device and an operating device, which includes an operating module accessible from the outside and inserted into the housing, which contains a touch input field on which operating commands can be entered and on which data can be displayed.

According to one embodiment, the toaster has a control unit which is configured to control a work programme selected on the touch input panel.

According to one embodiment, a desired heating temperature can be set on the touch input panel.

According to one embodiment, a desired heating time can be set on the touch input panel.

According to one embodiment, a desired heating power can be set on the touch input panel.

According to one embodiment, the toaster includes a transmitting and receiving unit configured for wireless transmission and reception of signals. This transmitting and receiving unit can be part of the operating module.

According to one embodiment, the control device also includes a mobile phone configured for wireless communication with the operating module.

According to one embodiment, the toaster includes at least one port via which energy from the rechargeable energy storage device can be transferred to an external device. This port can be provided on the operating module.

According to one embodiment, the toaster includes light sources. These light sources can be provided on the operating module.

According to one embodiment, the toaster includes a loudspeaker. This loudspeaker can be part of the operating module.

According to one embodiment, the toaster includes a microphone. This microphone can be part of the operating module.

According to one embodiment the toaster includes a heat attachment which can be positioned above the insertion slot and can be used to keep food warm, wherein the temperature, time and/or power used for keeping food warm can be set or selected on the touch input panel. This keep-warm function is limited by the capacity of the accumulator.

According to one embodiment, the heating elements are heating plates arranged on both sides of the heating chamber, the heating power of which can be individually adjusted.

According to one embodiment, the current remaining capacity of the rechargeable energy storage device can be displayed on the touch input panel.

According to one embodiment, the rechargeable energy storage device is an accumulator that can be positioned in a receptacle in the housing, can be removed from the housing for recharging and can be coupled to a charger connected to an alternating current network.

Alternatively, the rechargeable energy storage device can be permanently installed in the toaster and connected to an external charger via a charging contact.

According to one embodiment, a foldable handle is attached to the housing.

The embodiments described above can be used together, provided that they are not mutually exclusive.

An embodiment of the invention is explained in more detail below with respect to the drawings. It shows

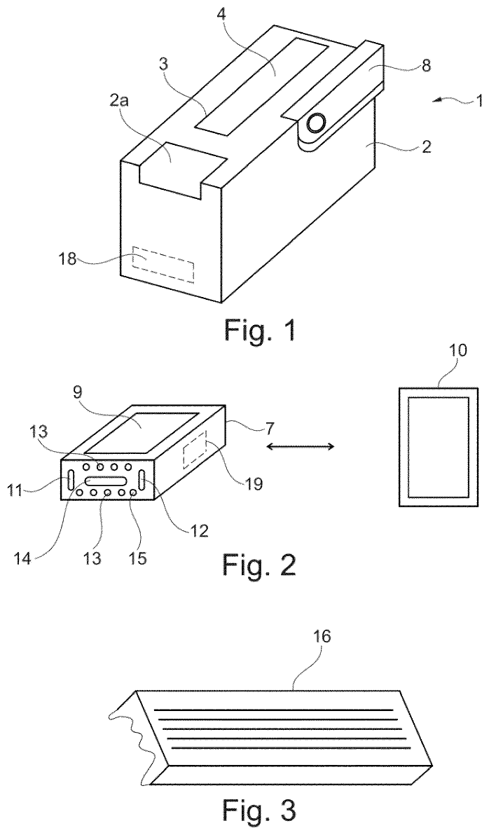

FIG. 1 shows a perspective sketch of the housing of a toaster,

FIG. 2 shows a perspective sketch of a operating device comprising an operating module and a mobile phone,

FIG. 3 shows a perspective sketch of a heat attachment,

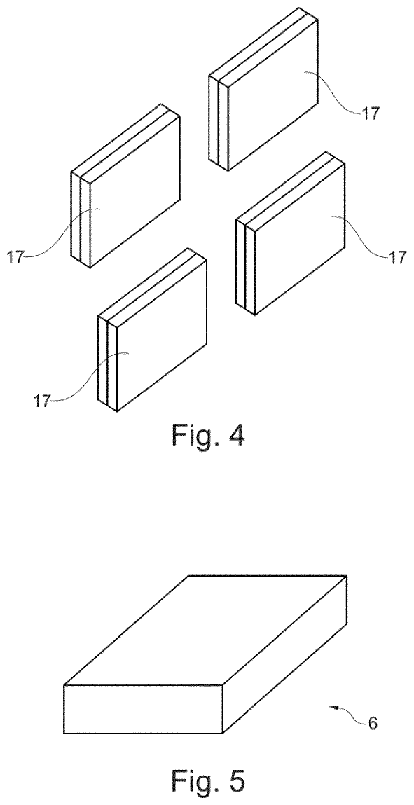

FIG. 4 shows a perspective sketch in which plate-shaped heating elements are shown, and

FIG. 5 shows a perspective sketch of a rechargeable energy storage device.

A toaster according to the present invention includes a housing, an insertion slot provided on the upper side of the housing, a heating chamber extending downward in the vertical direction from the insertion slot, heating elements adjacent to both sides of the heating chamber, a rechargeable energy storage device and an operating device comprising an operating module inserted into the housing and accessible from the outside, which contains a touch input panel on which operating commands can be entered and on which data can be displayed.

FIG. 1 shows a perspective sketch of the housing 2 of a toaster 1 equipped with the features of the invention. This housing 2 is essentially cuboid in shape. It has an insertion slot 3 provided on the upper side of the housing. Through this insertion slot 3, slices of toast bread, for example, which are to be toasted, can be inserted from above. The slices of toast inserted through the insertion slot 3 initially come to rest on an unillustrated grid, which can be lowered into a heating chamber 4 extending vertically downwards from the insertion slot 3 using an operating lever, which is not shown as well, within which the toasting process is carried out.

Furthermore, a foldable handle 8 is attached to the housing 2, which can be used to carry the toaster to a desired location when folded upwards. This desired location is, for example, a breakfast table on which the toaster can be used without the use of a cable connected to an alternating current power supply. This breakfast table can be located in the dining room of a private household, in the breakfast room of a restaurant or hotel, in a motorhome, in a caravan or in a hospital patient's room. The toaster can be transported wirelessly and easily to all these locations and operated there for as long as the charge of a rechargeable energy storage device inserted into the housing is sufficient.

The rechargeable energy storage device is realized, for example, in the form of a block-shaped accumulator, which is inserted into a receptacle 18 in the housing and from which the accumulator can be removed for recharging. This receptacle 18 can be closed by means of a hinged cover and can only be opened to insert the accumulator into the housing and to remove the accumulator from the housing. Alternatively, the accumulator can be fixed in the receptacle of the toaster, as already described, and connected to a charger via a charging contact.

Furthermore, the housing 2 shown in FIG. 1 has a recess 2a into which an externally accessible operating module 7 of an operating device can be inserted.

Such an operating module 7 is illustrated in FIG. 2. This operating module 7 includes a touch input field 9, a USBc port 11, a further USBc port 12, light-emitting elements 13, a loudspeaker 14 and a microphone 15. Furthermore, the operating module 7 shown in FIG. 2 in its interior a control unit 19 indicated by dashed lines in FIG. 2, which is configured to control and regulate the operation of the toaster, as will be explained below.

Operating commands can be entered on the touch input field 9. Furthermore, data can be displayed on the touch input field 9.

A menu display can be shown on the touch input field 9, in which work programmes are shown as individual icons or in a list. A user can select the desired work programme from these work programmes. The selected work programme is implemented by the control unit 19, which is configured to execute the selected work programme. The selected work programme is implemented using software associated with the selected work programme and stored in a non-volatile memory, taking into account sensor data provided by sensors installed in the toaster. These sensors include, for example, temperature sensors for measuring the temperature in the heating chamber and sensors for measuring the humidity and heat radiation of a slice of toast positioned in the heating chamber.

Furthermore, a desired temperature, a desired heating time and/or a desired heating power can also be set or selected on the touch input field 9. This can be achieved, for example, by displaying icons on the touch input field 9 after a desired operating programme has been selected, which indicate a respective desired parameter, for example the temperature, and by additionally displaying plus/minus icons next to these icons, which, when pressed, increase or decrease a parameter value associated with the respective selected parameter.

Furthermore, the current remaining capacity of the rechargeable energy storage device 6 can also be displayed on the touch input field 9 in alphanumeric or graphical form.

The USBc ports 11 and 12 shown in FIG. 2 enable the current charge capacity of the rechargeable energy storage device 6 located in the housing 2 to be shared. To achieve this sharing, part of the current charge capacity of the rechargeable energy storage device is made available at one or both USBc ports and from there via a connecting cable to an external device, for example to a laptop for its power supply.

The light sources 13 provided on the operating module 7 are LEDs that increase the brightness in the immediate vicinity of the toaster 1.

The loudspeaker 14 attached to the housing 2 allows the toaster 1 to be used as an entertainment device. For example, music programmes can be played via this loudspeaker 14, which are provided by a mobile phone 10 containing a radio receiver and transmitted via a wireless bidirectional connection from the mobile phone 10 to the operating module 7 and played back via the loudspeaker 14.

Furthermore, control data of the toaster that influence its operation can also be transmitted from the mobile phone 10 to the operating module 7 via the aforementioned wireless bidirectional connection and used by the control unit of the operating module to control the operation of the toaster.

Furthermore, image or video data can also be transmitted via this bidirectional connection and played back via the display of the mobile phone 10 or the touch input field 9 of the operating module 7, depending on the respective transmission direction.

The microphone 15 provided on the housing 2, enables via the loudspeaker 14 a wireless bidirectional transmission of voice signals between the mobile phone 10 and the toaster 1. This allows, for example, real-time conversations between a toaster located at a campsite and a mobile phone located far away from the campsite.

To implement this bidirectional connection, the operating module 7 has a transmitting and receiving unit that is configured for wireless transmission and reception of signals.

FIG. 3 shows a perspective sketch of a heat attachment 16. This heat attachment can be positioned above the insertion slot 3 on the upper side of the housing 2 of the toaster and can be used to keep food warm. The temperature, time and/or power used to keep the respective food warm can be set or selected on the touch input field 9. The warming attachment 16 is smooth on its upper side to form a warming plate and has openings on its side walls which allow the hot air emitted upwards through the insertion slot 3 to escape sideways during the warming process.

Alternatively, the heat attachment 16 can also be designed with a grid pattern on its upper side so that the hot air emitted through the insertion slot 3 can also escape upwards through the openings in the grid-patterned surface of the heat attachment 16.

FIG. 4 shows a perspective sketch in which plate-shaped heating elements 17 are shown. When the toaster is assembled, these plate-shaped heating elements are arranged adjacent to each other on both sides of the heating chamber 4 and can be controlled individually. This makes it possible, for example, to toast a slice of bread in the heating chamber so that it is fluffy or soft on one side and crispy on the other (toast balance).

FIG. 5 shows a perspective sketch of a rechargeable energy storage device 6, which is designed in the form of a cuboid accumulator. During operation of the toaster, this accumulator is positioned in the receptacle 18 of the housing 2 of the toaster and can be removed from the housing for recharging and coupled to a charger connected to an alternating current network using charging contacts or inductively.

A toaster with the features described above allows the toaster to be used on a breakfast table without the need for a cumbersome cable connection. In addition, a toaster with the features described above has further advantages.

One of these advantages is that it can be easily transported to a desired location and operated there without a cable.

Another advantage is improved operability through the use of an operating module with its own touch input field on which operating commands can be entered and data can be displayed. Operating options can be displayed simultaneously or sequentially on this touch input field, from which the user can select one or more without the need for a plurality of control buttons.

The usability of the toaster is further improved by using a operating device including an operating module with a touch input field and a mobile phone coupled to the operating module via a wireless communication link. This allows software data that influences the operation of the toaster to be transferred from the mobile phone to the toaster.

Alternatively, the toaster can also be operated using an app.

The accumulator removed from the toaster housing for recharging can be charged using a wide-range power supply on a charging station with almost any voltage and current. Alternatively, accumulators are permanently installed in the toaster and are charged via contact surfaces or inductively from an external charging station.

Further advantages of the toaster described above include the option of temperature control by entering a desired temperature in ° C., power control by entering a desired power in watts, and time control by entering a desired duration for a heating or warming process.

A toaster with the features described above can serve as a Wi-Fi access point and can be connected to other electrical or electronic devices located near the toaster via a Bluetooth/Wi-Fi connection.

It also allows its charging capacity to be shared with other external devices, for example via a USBc port.

The use of light sources, such as LEDs, enables a lighting function.

By using one or more loudspeakers, a microphone and/or the display, the toaster can also be used as a communication device or entertainment device.

By using a heat attachment above the insertion slot, heat from the heating chamber can be used to keep food warm, either by warm air flowing upwards or by using so-called heat pipe technology. This can also be controlled by means of time, temperature and/or power control.

By influencing the heating power of the heating elements arranged on both sides of the heating chamber, which may be heating plates, the degree of browning of each slice of toast can be adjusted to the individual preferences of the user. For example, a slice of toast can be soft on one side and crispy on the other (heating balance, power balance, toast balance).

The mobility of the toaster described above allows the following scenarios to be realized:
Use of the toaster in a motorhome on a campsite:

It is important to note that, given the current state of the art, connecting a conventional toaster directly to the motorhome's electrical system results in high energy consumption in a short period of time and is therefore not recommended. With a toaster such as the one described above, the rechargeable accumulator can be charged over a longer period of time with low power using the available on-board power supply.
Use of the toaster in gastronomic businesses:

This allows toast to be prepared individually at the table of the respective hotel guest. Suitable communication software enables hotel staff to monitor the availability of the available toasters and to provide the respective guest with a charged appliance in good time.
A keep-warm function:

Desired temperature/power/time control allows the existing heating elements to be influenced by means of phase angle control or pulse width control. By specifying a desired keep-warm time, it is possible to maintain the keep-warm time for the desired period and automatically switch it off after this time has elapsed.

The toaster is operated as described above using the operating module, on whose touch input panel operation commands can be selected or entered and data can be displayed. In this way, in particular, a desired toasting time and a desired heating power can be set and the currently remaining capacity of the rechargeable energy storage device can be displayed. The toasting process itself can be activated in the conventional manner by pressing down a lever. Each slice of toast can be ejected in a convenient manner by means of a gentle upward movement using a friction motor and not, as in known toasters, by means of an unregulated upward ejection using a spiral spring. This also provides a mechanical protective function. Heating programmes with reduced power can also be implemented without operating a lever.

It is always possible to adjust the heating power via an app. The toasting process is started by pressing down a lever or slider. The toasting process can also be started without operating the lever or slider, but for safety reasons only with greatly reduced heating power.

List of reference signs

| | |
|---|---|
| 1 | Toaster |
| 2 | Housing |
| 2a | Recess in the housing |
| 3 | Insertion slot |
| 4 | Heating chamber |
| 5 | Heating elements |
| 6 | Rechargeable energy storage device |
| 7 | Operating module |
| 8 | Handle |
| 9 | Touch input panel |
| 10 | Mobile phone |
| 11 | USBc port |
| 12 | USBc port |
| 13 | Light source |
| 14 | Loudspeaker |
| 15 | Microphone |
| 16 | Heat attachment |
| 17 | Heating elements |
| 18 | Receptacle for the rechargeable energy storage device |
| 19 | Control unit |

1. A toaster, comprising:
a housing (2),
an insertion slot (3) provided on the upper side of the housing,
a heating chamber (4) extending vertically downwards from the insertion slot (3),
heating elements (5) adjacent to both sides of the heating chamber (4),
a rechargeable energy storage device (6) and
an operating device (7, 10),
wherein the operating device comprises an operating module (7) inserted into the housing (2) and accessible from the outside, which contains a touch input panel (9) on which operating commands can be entered or selected and on which data can be displayed,
wherein the toaster comprises a heat attachment (16) which can be positioned above the insertion slot and can be used to keep food warm, wherein the temperature, time and/or power used for keeping food warm can be set or selected on the touch input panel (9).

2. The toaster according to claim 1, which comprises a control unit (19) configured to control a work program selected on the touch input panel (9).

3. The toaster according to claim 1, in which a desired heating temperature and/or a desired heating time can be set on the touch input panel (9).

4. The toaster according to claim 1, wherein a desired heating power can be set on the touch input panel (9).

5. The toaster according to claim 1, which comprises a transmitting and receiving unit configured for wireless transmission and reception of signals.

6. The toaster according to claim 5, wherein the operating device (7, 10) further comprises a mobile phone (10) which is configured for wireless communication with the operating module (7).

7. The toaster according to claim 1, which has a port (11, 12) via which energy can be transferred from the rechargeable energy storage device (6) to an external device.

8. The toaster according to claim 1, which comprises light sources (13).

9. The toaster according to claim 1, which comprises a loudspeaker (14).

10. The toaster according to claim 1, which comprises a microphone (15).

11. (canceled)

12. The toaster according to claim 1, in which the heating elements are heating plates (17) arranged on both sides of the heating chamber, the heating power of which is individually adjustable.

13. The toaster according to claim 1, wherein the current remaining capacity of the rechargeable energy storage device (6) can be displayed on the touch input panel (9).

14. The toaster according to claim 1, wherein the rechargeable energy storage device (6) is an accumulator that can be positioned in a receptacle (18) of the housing (2), can be removed from the housing for recharging and can be coupled to a charger connected to an alternating current network, or in which the rechargeable energy storage device is permanently installed in the toaster.

15. The toaster according to claim 1, wherein a foldable handle (8) is attached to the housing (2).
